(19) United States
(12) Patent Application Publication
(10) Pub. No.: US 2024/0265016 A1
(43) Pub. Date: Aug. 8, 2024

(54) GENERATION OF OPTIMIZED DATA CUBES

(71) Applicant: International Business Machines Corporation, Armonk, NY (US)

(72) Inventors: Deng Xin Luo, Xian (CN); Jun Guo, Xian (CN); Yi Ming Wang, Xian (CN); Mu Dan Cao, Beijing (CN); Yu Zui You, Ningbo (CN); Rong Fu He, Beijing (CN)

(21) Appl. No.: 18/163,431

(22) Filed: Feb. 2, 2023

(51) Int. Cl. G06F 16/2453

(52) U.S. Cl. CPC G06F 16/24547

(57) ABSTRACT

Generation of optimized data cube(s) includes obtaining data queries, parsing the data queries and ascertaining dimension and measure information, including dimension tables and fact tables indicated in the data queries, analyzing the dimension and the measure information for relationships between the dimension tables and fact tables, and strengths of the relationships, segmenting dimensions and measures reflected in the dimension and the measure information, including the dimension tables and fact tables, into one or more communities, each community including at least one dimension table of the dimension tables and at least one fact table of the fact tables, and generating an optimized data cube for each community and having a respective dimension table for each of the at least one dimension table of the community and a respective fact table for each of the at least one fact table of the community.

### BACKGROUND

Datasets size has increased dramatically in recent years and it is not uncommon for an organization query against large-scale, massive datasets in the petabyte scale. Querying datasets of that size have practical implications to ensure adequacy in query handling time and efficiency. One specific application is business intelligence systems that build analysis indicators for massive data.

Online analytical processing (OLAP), an approach to answering multi-dimensional analytical queries, has conventionally been one mode for large-scale analysis of petabyte-level datasets. A relatively new query mode for use in OLAP is the data cube (sometimes referred to as “datacube”)—a multi-dimensional array of values leveraging pre-computing and storage space to index results. Index results are calculated and stored, and, when a query is performed, a strategy can quickly obtain from the data cube and output the query results relatively quickly and efficiently.

### SUMMARY

Shortcomings of the prior art are overcome and additional advantages are provided through the provision of a computer-implemented method. The method obtains a collection of data queries. The method also parses each data query of the collection of data queries and ascertains, from the parsing, dimension and measure information of the data queries. The dimension and measure information includes dimension tables and fact tables indicated in the data queries. Additionally, the method analyzes the dimension and measure information for relationships between the dimension tables and fact tables, and strengths of the relationships. Further, the method segments dimensions and measures reflected in the dimension and measure information, including the dimension tables and fact tables, into one or more communities based on the analyzing. Each community of the one or more communities includes a respective at least one dimension table of the dimension tables and at least one fact table of the fact tables. Yet further, the method generates optimized data cube(s). Generating the optimized data cube(s) includes, for each community of the one or more communities, generating an optimized data cube with a respective dimension table for each of the at least one dimension table of the community and a respective fact table for each of the at least one fact table of the community.

Further, a computer system is provided that includes a memory and a processor in communication with the memory, wherein the computer system is configured to perform a method. The method obtains a collection of data queries. The method also parses each data query of the collection of data queries and ascertains, from the parsing, dimension and measure information of the data queries. The dimension and measure information includes dimension tables and fact tables indicated in the data queries. Additionally, the method analyzes the dimension and measure information for relationships between the dimension tables and fact tables, and strengths of the relationships. Further, the method segments dimensions and measures reflected in the dimension and measure information, including the dimension tables and fact tables, into one or more communities based on the analyzing. Each community of the one or more communities includes a respective at least one dimension table of the dimension tables and at least one fact table of the fact tables. Yet further, the method generates optimized data cube(s). Generating the optimized data cube(s) includes, for each community of the one or more communities, generating an optimized data cube with a respective dimension table for each of the at least one dimension table of the community and a respective fact table for each of the at least one fact table of the community.

Yet further, a computer program product including a computer readable storage medium readable by a processing circuit and storing instructions for execution by the processing circuit is provided for performing a method. The method obtains a collection of data queries. The method also parses each data query of the collection of data queries and ascertains, from the parsing, dimension and measure information of the data queries. The dimension and measure information includes dimension tables and fact tables indicated in the data queries. Additionally, the method analyzes the dimension and measure information for relationships between the dimension tables and fact tables, and strengths of the relationships. Further, the method segments dimensions and measures reflected in the dimension and measure information, including the dimension tables and fact tables, into one or more communities based on the analyzing. Each community of the one or more communities includes a respective at least one dimension table of the dimension tables and at least one fact table of the fact tables. Yet further, the method generates optimized data cube(s). Generating the optimized data cube(s) includes, for each community of the one or more communities, generating an optimized data cube with a respective dimension table for each of the at least one dimension table of the community and a respective fact table for each of the at least one fact table of the community.

Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example conceptual diagram of conventional OLAP-based query handling using a data cube;

FIG. 3 depicts an example conceptual diagram of generation of optimized data cubes in connection with OLAP-based query handling using data cube(s), in accordance with aspects described herein;

FIG. 4 depicts an example workflow of generating optimized data cubes, in accordance with aspects described herein;

FIG. 5 depicts an example community graph in accordance with aspects described herein;

FIG. 6 depicts an example of a pruned community graph generated from the community graph of FIG. 5, in accordance with aspects described herein;

FIG. 7 depicts further details of an example data cube generation module to incorporate and/or use aspects described herein; and

FIG. 8 depicts an example process for generation of optimized data cubes, in accordance with aspects described herein.

### DETAILED DESCRIPTION

Described herein are approaches for generating data cubes optimized for query handling, the generating being based on a history of queries issued for data to be incorporated into the data cubes.

In the practical use of data cubes, the selection of dimensions and measures (measures are also referred to as ‘facts’ or ‘metrics’ in data cube terminology) is a critical step. However, in practice, it is often the case that the selection of dimensions and measures for maintained data cube(s) does not meet the requirements of the actual queries being received for handling. This results in an inefficiency. The growth of business indicators, for instance, renders the maintained data cube(s) unable to meet the requirements of the actual queries being received for handling, resulting in queries hitting multiple of the data cubes in the final use of the query. This deviates from the essence of OLAP and negatively impact query handling efficiency.

Presented herein are approaches for automatic generation of optimized data cubes based on business indicators in issued data queries. The automatic generation can include, for instance, automatically extracting dimension and measure information of the data queries being used, analyzing the dimensions and measures used in those queries, performing knowledge graph correlation analysis and optimization, and generating optimized data cube(s) based on the foregoing. This helps to ensure that the generated, optimized data cube(s) are most likely to be hit by incoming queries, which in turn helps to maximize query efficiency and may be particularly advantageous for massive datasets (e.g., 1 petabyte and larger). Aspects can be iteratively and automatically deployed to generate new sets of optimized data cubes from time to time, thus ensuring that the latest optimized data cubes have been tailored to the latest data queries being submitted, for instance.

According to some embodiments as described herein, a process can parse dimension and measure information, including, for instance, indications of dimension tables, dimensions (usually a certain column of a dimension table), fact tables, metric columns (or ‘measure fields’) of the fact tables, and metrics (or ‘measures’), out of a snapshot of data query statements at a given point in time, then use a knowledge graph to analyze common dimension and metric relationships between different queries, identify and output common dimension-metric ‘communities’, and then optimize the set of data cubes based on the dimension-measure relationships exhibited.

As noted, aspect may be particularly useful for applications in which petabyte-scale ‘big data’ queries are performed. Aspects can be used when building data cubes, and used iteratively over time to refresh data cubes being maintained in order to keep the cubes fresh and optimized.

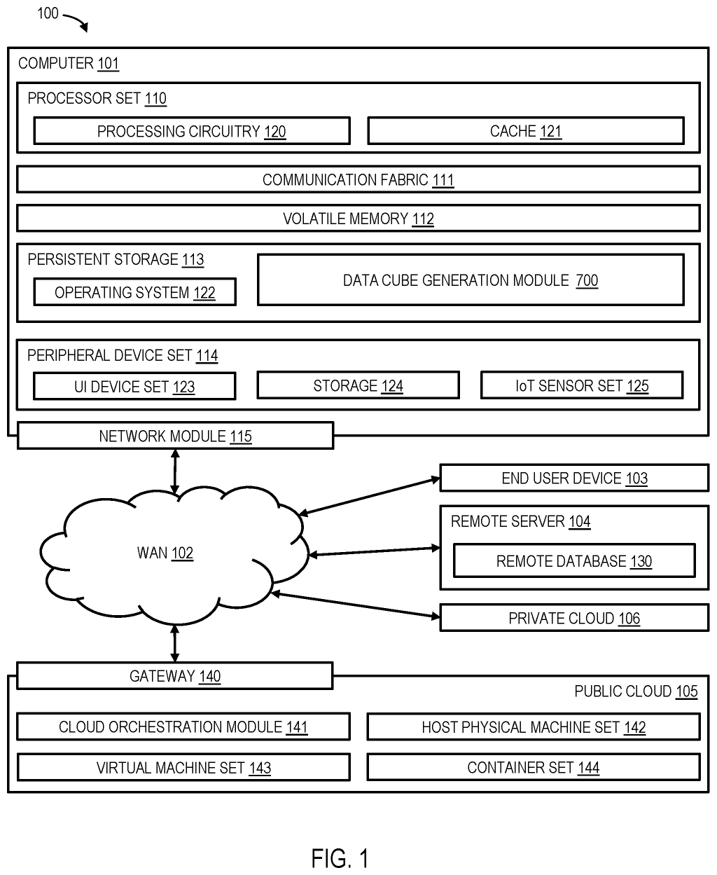

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code of data cube generation module 700. In addition to block 700, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 700, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 700 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 700 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above in FIG. 1 is only one example of a computing environment to incorporate, perform, and/or use aspect(s) of the present invention. Other examples are possible. For instance, in one or more embodiments, one or more of the components/modules of FIG. 1 are not included in the computing environment and/or are not used for one or more aspects of the present invention. Further, in one or more embodiments, additional and/or other components/modules may be used. Other variations are possible.

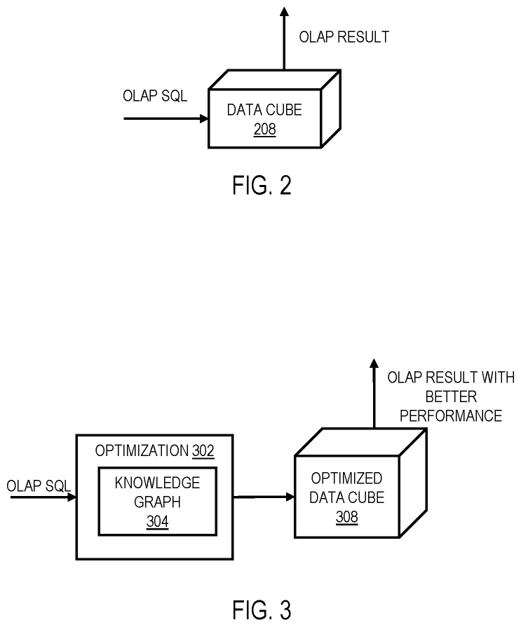

FIG. 2 depicts an example conceptual diagram of conventional OLAP-based query handling using a data cube, in which an OLAP query (as SQL in this example) is issued and ‘hits’ the data cube 208, meaning data requested by the query is provided by the data cube, and OLAP result(s) are output. Many times an original data cube (e.g., 208 of FIG. 2) is constructed with an initial design, e.g., dimension/measure parameters, being based on expert experience/knowledge. This can be effective initially, but the design of the original cube may become stale as the business and indicators change over time.

In accordance with aspects described herein, generation of optimized data cubes is provided that can leverage existing cube design together with information from a collection of data queries, for instance those that have been logged into a query log as queries issued recently against existing/initial data cube(s), to build a correlation graph (also referred to herein as “community” graph and “knowledge” graph) that correlates dimension and measure information of the queries, thereby combining the expert experience imparted in the initial design with information of the queries actually being issued against the data cubes. The expert experience may be captured in a mapping dictionary discussed below, while the collection of queries provide the desired correlation between the dimension tables, fact tables, indicators, facts, etc. of the existing system for building optimized data cube(s).

FIG. 3 depicts an example conceptual diagram of generating an optimized data cube in connection with OLAP-based query handling using data cube(s), in accordance with aspects described herein. Optimization 302 in the form of a method/process is performed against data queries, as SQL in this example. The optimization builds and uses a knowledge graph 304. The optimization 302, based on the knowledge graph 304 as explained herein, generates optimized data cube 308. The optimized data cube 308 provides a better hit rate for incoming queries, for instance those that are issued after the optimization, providing better performance in OLAP result output. In examples, the optimization 302 generates multiple data cubes 308 to be used in query handling.

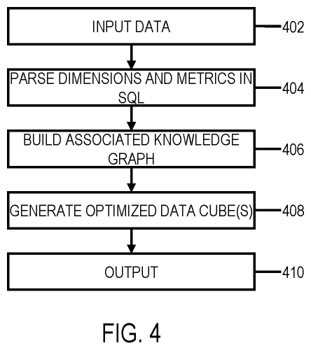

FIG. 4 depicts an example workflow of generating optimized data cubes, in accordance with aspects described herein. In some examples, the workflow is performed iteratively, e.g., whenever a collection of data cube(s) is to be refined and optimized based on recent data queries.

Examples provided herein use SQL data queries as just one example of data queries. This is by way of example only and not limitation.

The workflow of FIG. 4 begins with data being input (402), the data being/including a collection of data queries, for instance as the query text/statements of those queries. The data queries could be queries from a query log, for instance a log/history of all incoming queries to a query handler or other system. In examples, the query history includes queries made against one or more initial data cubes that already exist.

As a specific example, the inputting (402) selects n SQL query statements from a log/queue using parameter(s) that dictate how to select queries to form the collection for input. The parameter(s) could specify a specific number for n (such as 10,000) and therefore the collection could be the n most recent queries of the log, as an example. As an alternative, the parameter(s) could specify a lookback amount of time (for instance one month), and the collection could therefore be all queries from the last month. There are various approaches for selecting the queries to input. A goal of whichever approach is taken may be to provide an accurate representation of the distribution of real user queries that may be, or are expected to be, submitted for handling.

By way of specific example to help illustrate aspects described herein, the following presents four example SQL queries (labeled SQL1, SQL2, SQL3, SQL4) of a collection that may be input:
SQL1: select A, B, C, sum(a), avg(a) from FT1 join DT1 group by A, B, C
SQL2: select D, E, F, avg(b),count(b) from FT2 join DT1 group by D, E, F
SQL3: select B, C, avg(c), count(c), sum(c) from FT2 join DT2 group by B, C
SQL4: select G, H, avg(d), sum(d) from FT3 join DT3 group by G, H

The workflow of FIG. 4 continues by parsing (404) each query of the collection of data queries for the dimensions and metrics presented therein, to ascertain, from the parsing, dimension and measure information of the data queries. SQL parsing technology can be used to parse out such dimension/measure information as dimension tables and metric columns indicated in each of the SQL queries. The parsed information can then be output as dimensions and metrics used in the data queries SQL.

In examples, the dimension and measure information can include dimension tables and fact tables indicated in the data queries, as well as dimensions corresponding to the dimension tables, metric columns corresponding to the fact tables, and metrics corresponding to the metric columns. A dictionary mapping can be used in the parsing. Specifically, the dictionary can define/identify for the parser the dimensions, dimension tables, metrics, metric columns, and fact tables for correlation to query elements appearing in the input data query statements. This can be done through rules or other directives to the parser. The dictionary can capture the expert knowledge/experience discussed above of the initial cube design and the process can use this in determining which segments of the query scripts are dimensions, metrics, metric columns, etc. By way of example, the dictionary might specify that the keyword/phrase “group by” may be followed by a dimension table, the keyword “select” may be followed by a dimension field and a metric column, and aggregate functions such as avg( ) and sum( ) may be metrics. In examples, these specifications are obtained from system developers according to different system use experience and implemented in one or more dictionaries for parsing.

Using the SQL examples above, dimensions can be identified by taking elements following the ‘select’ or ‘group by’ clauses (e.g., A, B, C, D, E, F, G, H). These dimensions are taken from tables DT1, DT2, DT3 (identified as dimension tables). Meanwhile, aggregate functions (like sum(a), avg(a), count(b), etc.) are identified as metrics, and the elements that metrics operate on (e.g., a, b, c, d) are identified as metric columns from tables FT1, FT2, FT3 that are identified as fact tables.

The SQL is processed, and counts of the dimension and measure information (fact tables, dimension tables, dimensions, indicators, measure fields and other information) that appear in each SQL can be maintained. In a specific example, each SQL is converted into a record with each input SQL being identified by a Key and the corresponding dimensions and measures thereof being Values. Each such record identifies the Values (dimensions—“Dim”, dimension tables—“DimTable”, fact tables—“FactTable”, metrics—“Metrics”, and metric columns—“MetricColumn”) of the input SQL query corresponding to the Key. Using the example four SQL statements from above, these could be converted to the following four records:
SQL1:([Dim, A], [Dim, B], [Dim, C], [MetricColumn, a], [Metrics, sum(a)], [Metrics, avg(a)], [FactTable, FT1],[DimTable,DT1])
SQL2:([Dim, D], [Dim, E], [Dim, F], [MetricColumn, b], [Metrics, avg(b)], [Metrics, count(b)]], [FactTable, FT2], [DimTable, DT1])
SQL3:([Dim, B], [Dim, C], [MetricColumn,c], [Metrics, avg(c)], [Metrics, count(c)], [Metrics, sum(c)]], [FactTable, FT2], [DimTable,DT2])
SQL4:([Dime, G], [Dim, H], [MetricColumn, d], [Metrics, avg(d)], [Metrics, sum(d)]], [FactTable, FT3], [DimTable, DT3])

By way of another specific example, consider the following SQL statement:
SELECT market, category, sum(sales) as sumsales FROM ods. fact_table fact INNER JOIN dm. dm_product_dim prod ON prod.category=fact.category AND prod.market=fact.market GROUP BY market, category.

In this example, market and category are identified as dimensions, sum(sales) is identified as a metric, sales is identified as a metric column, ods. fact_table is identified as a fact table, and dm. dm_product_dim is identified as a dimension table. The corresponding summary record generated from the above to identify the dimension and measure information is as follows: ([Dim, market], [Dim, category], [MetricColumn, sales], [Metrics, sum(sales)], [FactTable, ods. fact_table], [DimTable,dm. dm_product_dim]).

With the dimension and measure information having been identified, the process proceeds by building (406) an associated knowledge graph. For instance, the process analyzes the dimension and measure information for relationships between the dimension tables and fact tables, and strengths of the relationships, and uses this to build the knowledge graph. Initially, the SQL parse results can be summarized in tables based on the Values from the SQL records discussed above. The relationships identified include fact table-dimension table co-occurrences in the queries, meaning instances where a fact table-dimension table pair appear in a query of the collection. A strength of such a relationship can be based on the number of such queries, of the collection queries, in which that fact table-dimension table pair appear. Table 1 illustrates an example:

TABLE 1

| | | # co-occurrences | # total queries | Percentage |
|---|---|---|---|---|
| Fact Table | Dimension Table | (count 1) | (total_count) | (count1/total count) |
| [FactTable, FT1] | [DimTable, DT1] | 3000 | 10000 | 0.3 |
| [FactTable, FT2] | [DimTable, DT1] | 3000 | 10000 | 0.3 |
| [FactTable, FT2] | [DimTable, DT2] | 6000 | 10000 | 0.6 |
| . . . | . . . | . . . | . . . | . . . |

The first and second columns of Table 1 are Fact Table and Dimension Table columns, respectively. Each row (other than the top row) corresponds to a fact table-dimension table pair that co-occurs in one or more queries of the collection. By ‘co-occurs’ is meant that the given fact table, of the identified fact tables from the collection of queries, and the given dimension table, of the identified dimension tables from the collection of queries, appear in the same query. The third column (# co-occurrences) is the count (count 1) of the number of queries, in the collection, in which both v1 (the fact table identified in column 1) and v2 (the dimension table identified in column 2) appear. Using fact table FT2 and dimension table DT2 (represented by the fourth row in Table 1) as an example, these two tables appear in 6,000 queries of the total number of queries in the collection (10,000—given in the fourth column in Table 1). The last column of Table 1 presents a percentage of co-occurrences (based on the number in column 3) appearing in the total number of queries (column 4) of the collection. Thus, Table 1 summarizes the SQL parse results from above as a number and percentage of fact table-dimension table co-occurrences in the queries.

As part of an example summarization of the SQL queries, also provided is a table indicating Value pairs and whether they co-occur in any of the queries of the collection. Table 2 presents an example:

TABLE 2

| V1 | V2 | Co-occur? |
|---|---|---|
| [DimTable, DT1] | [Dim, A] | 1 |
| [FactTable, FT1] | [MetricsColumn, a] | 1 |
| [MetricsColumn, a] | [Metrics, sum(a)] | 1 |
| . . . | . . . | . . . |

Table 2 includes first and second columns setting forth a first value (V1) and second value (V2), respectively, and a third column to indicate whether V1 and V2 co-occur in any query of the collection. Each row of Table 2 (except for the first row—the header row) therefore indicates by way of a flag in the third column whether the V1 value and V2 value are both indicated in any query of the collection. More specifically, Table 2 summarizes the SQL parse results from above as indications of whether the following types of co-occurrences occur: (i) given fact tables and given measure fields (i.e., metric columns), (ii) given measure fields and given indicators (i.e., metrics), and (iii) given dimension tables and given dimensions. In other words, Table 2 can indicate (i) each fact table-metric column pair that co-occurs in at least one query (an example such pair is presented in the third row of Table 2), (ii) each metric column-metric pair that co-occurs in at least one query (an example such pair is presented in the fourth row of Table 2), and (iii) each dimension table-dimension pair that co-occurs in at least one query (an example such pair is presented in the second row of Table 2).

Tables 1 and 2 present example summary information. Ultimately, the process may desire to segment the dimensions and measures reflected in this dimension and measure information into communities, and do so based on what is reflected by the summary information. One approach to accomplish this is to use the summary information to create a community graph (e.g., knowledge graph discussed above) that can be segmented.

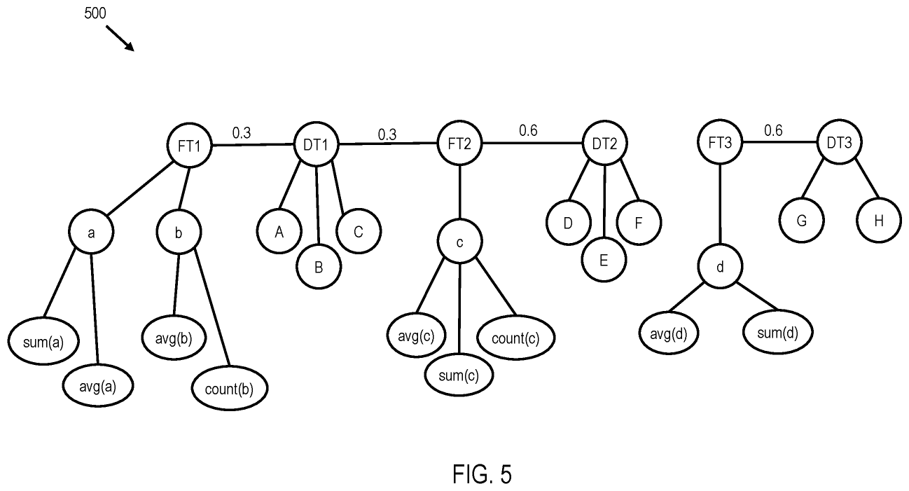

FIG. 5 depicts an example community graph in accordance with aspects described herein. Graph 500 of FIG. 5 presents an example graph generated from information in Tables 1 and 2 above (only some of which was shown in the example Tables above), and presents a relatively basic example. In practice, and depending on the size of the collection of queries and the number of different dimensions and metrics involved, the graph could include hundreds or thousands of nodes and edges.

A process builds the community graph by generating and inserting a respective dimension table node for each dimension table of the identified dimension tables and a respective fact table node for each fact table of the identified fact tables. In this example, fact tables FT1, FT2, and FT3, and dimension tables DT1, DT2, and DT3 have been identified and therefore a respective node for each has been provided in graph 500. The process also provides, for each fact table-dimension table pair that co-occurs (as reflected by Table 2 for instance), an edge between the corresponding fact table node and dimension table node in the graph. Each such edge is provided with a weight based on the number of queries, of the data queries of the collection, in which the fact table and the data table of the fact table-dimension table pair both appear. In this example, the weight of each edge is assigned and provided as the percentage of co-occurrences of the fact table-dimension table (as reflected by column five of Table 1). Thus, the weight of the edge between the FT2 node and DT2 node is 6,000/10,000=0.6, which the percentage taken from row four of Table 1 reflecting the co-occurrences of fact table FT2 and dimensions table DT2 across the collection of queries. There were no co-occurrences in this example of various dimension table-fact table pairs, for instance {DT2, FT3}, {DT1, FT3}, {DT2, FT1}, {DT3, FT1} and {DT3, FT2}, and therefore there are no edges provided between the corresponding node pairs in FIG. 5.

The process additionally generates and inserts nodes for the dimensions, metric columns, and metrics seen to co-occur with dimension tables/fact tables (e.g., by Table 2) in the collection of queries. Such inserted dimension nodes are related (as child nodes in the example of FIG. 5) to the dimension table nodes in which the dimensions appear, the inserted metric column nodes are related (as child nodes in the example of FIG. 5) to the fact tables to which they correspond, and the inserted metric nodes are related (as child nodes in the example of FIG. 5) to the metric columns to which they correspond. In FIG. 5, dimensions A, B, and C are dimensions of dimension table DT1 and therefore corresponding nodes for dimensions A, B, and C are inserted and related (by an edge) to the dimension table node for dimension table DT1, as shown. Similarly, nodes for dimensions G and H are related to the node for dimension table DT3. In addition, metric column nodes for metric columns a and b are related to the node for fact table FT1. Metrics sum(a) and avg(a) correspond to metric column a, and therefore their respective nodes are related to the node for metric column a. Based on examining all of the relations reflected in the dimension and measure information from the original queries, the community graph is built in full as is shown in FIG. 5. The graph includes nodes for five different types of dimension/measure information: fact tables, dimension tables, dimensions, metrics, and metric columns. The example of FIG. 5 happens to present an example in which the graph is disconnected/disjoint, though this is coincidental and is based on the co-occurrences that happened to occur in the example queries of the collection.

The graph 500 presents a way of working with the summarized information, for instance the information set forth in Tables 1 and 2 above. Such information from Table 1 can inform a community discovery to discover discrete ‘communities’ that link fact table(s) with dimension table(s) and identify which of those should be included or excluded from the different communities based on the co-occurrence percentages. The information in Table 2 can inform of the relations that exist between (i) the dimension tables and dimensions, and (ii) the fact tables, metric columns, and metrics.

As noted above, a process can segment the dimensions and measures reflected in the dimension and measure information, including the dimension tables and fact tables, into one or more communities based on the analysis. Each such community can include at least one dimension table of the identified dimension tables and at least one fact table of the identified fact tables. In examples, each fact table appears in only one community and each dimension table appears in only one community.

To discover the discrete communities involved, a community exploration algorithm can be performed based on the relations seen and the strength of those relations. The community graph built as described above can facilitate this, with the community exploration algorithm being performed against the community graph to output one or more communities discovered by the algorithm. In a particular example, the Girvan-Newman algorithm, which is a known algorithm for community discovery, is applied against the community graph to divide it into one or more communities. This segments the community graph, representing the dimensions and measures discovered from the query collection, into subgraphs of the community graph. Each subgraph represents a community that was discovered, and therefore indicates dimension table(s) of the community represented by the subgraph and fact table(s) of the community represented by the subgraph.

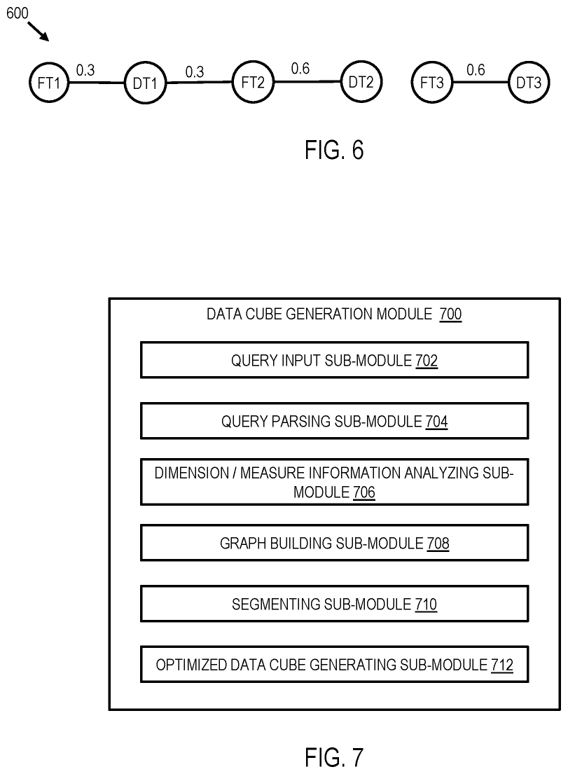

As part of this community identification using the community graph (e.g., 500), the process might first remove (or ignore) the nodes representing anything other than fact tables and dimension tables. Conceptually, this results in a pruned community graph 600 shown in FIG. 6, which includes the weights of the relations between the fact table-dimension table pairs.

The community discovery algorithm, for instance the Girvan-Newman algorithm or a different community discovery algorithm, may be performed against the pruned graph to obtain the corresponding community division. In this example, the algorithm might identify two communities: (i) the subgraph represented by the nodes for fact tables FT1 and FT2 and dimension tables DT1 and D2, and (ii) the subgraph represented by the nodes for fact table FT3 and dimension table DT3. In general, this segmenting of the community graph can include applying a community discovery algorithm using the weights assigned to the edges of the community graph to segment the community graph, with the weights each indicating a strength of a relationship between the corresponding dimension table and fact table, and the strength of the relationship being based on a number of queries, of the data queries, in which the dimension table and the fact table both appear.

Based on the community division, each community, including dimension table and fact table information, as well as the dimensions, metrics, and metric columns included in the community (and easily determined referring to the original graph 500), and the workflow of FIG. 4 can generate (408) optimized data cube(s) based thereon. Specifically, an optimized data cube can be generated for each community of the discovered communities.

As an example of generating an optimized data cube for a community, initially the community graph (e.g., 500) (or the subgraph for that community) is used to inform which dimension/measure elements are involved. For each dimension table of the community indicated by the subgraph, the process generates a dimension table of the optimized data cube, finds, in the graph, each dimension associated with that dimension table, and sets it as the dimension of the corresponding generated dimension table of the data cube (e.g., dimension table node DT1 is associated with dimension nodes A, B, C, so A, B, C fields of the dimension table DT1 in the cube are set as dimensions).

Additionally, for each fact table of the community indicated by the subgraph, the process generates a fact table of the optimized data cube, finds, in the graph, each metric column associated with the fact table, and sets it as a measure field of the generated fact table of the data cube (e.g., fact table node FT1 is associated with metrics column nodes a, b, and so a and b fields of fact table FT1 in the cube are set as measure fields). Further, for each metric corresponding to a respective metric column, the process sets the metric as a measure of the measure field that was set (e.g., the a metric column node in FIG. 5 is associated with the sum(a) and avg(a) metrics nodes, so sum and average indicators are set for the metric field a in the data cube).

By performing this process iteratively for each community identified, a corresponding number of optimized data cubes is generated and then output (410, FIG. 4). In the example above, the process generates two optimized data cubes corresponding to the two discovered communities. The optimized data cubes can then be used for OLAP processing. This is expected to provide better query performance, as the queries are expected to hit the right metrics/dimensions already calculated in the optimized data cubes, thus resulting in improvement in query handling performance. Whereas a query issued previously might not hit any initial data cube, the query is expected to hit one or more of the optimized data cubes for a calculated result. Based on the optimization, the dimensions and metrics have already been calculated in an optimized cube, which enables the cube to provide a calculated result in response to the query for better performance that a non-hit.

In some embodiments, there is a set of initial data cube(s) against which OLAP processing is performed. In this case, the collection of data queries used in the generation of optimized data cubes may be obtained from a query history that includes queries made against those one or more initial data cubes. The optimized data cubes can replace those initial data cube(s), if desired. For instance, the optimized data cube(s) may be provided in place of the initial data cube(s) for satisfying later-incoming queries. Further, activities undertaken above to produce the optimized data cube(s) might have identified and provided the optimized data cube(s) dimension(s) and/or metric(s) that were not included in the initial data cube(s). Additionally, the number of initial data cube(s) and optimized data cube(s) might not align. For instance, the optimization might have resulted in a fewer number of (optimized) data cubes than initial data cubes that were initially involved in handling the queries. Conversely, the number of optimized data cubes might be greater than the number of initial data cubes.

In an example of outputting an optimized data cube, some dimensions and metric columns were not included in original data cube but are to exist in an optimized data cube along with a corresponding metric. The original data cube can therefore be optimized by adding these dimensions, metric columns, and corresponding metric. For example, in a sales scenario, ‘secondary suppliers’ may initially be only reserved columns—not actually used. However, development of the business may have resulted in these suppliers being divided into more fine-grained categories and desired analysis (evinced through queries) might wish to utilize statistical data of the secondary suppliers. In this situation, columns representing secondary suppliers are to be added in the optimized data cube to support more efficient queries. In yet another example of outputting an optimized data cube, a new data cube may be generated, for instance to hold fact tables and fields that may not exist in any of the initial data cube(s). Take an example where analysis of historical queries finds that fact table A and dimension table B are in a group. However, it is also found that none of the initial data cubes contains fact table A and dimension table B. In this case, the process can create a new data cube to include fact table A and dimension table B (as well as the corresponding dimensions, metric fields and metrics). This kind of scenario might occur as a result of business development/function launch of an enterprise.

In examples, a ‘recommended data cube model’ may be generated based on the community detection and output to a system that generated the optimized data cube(s) therefrom. The model can present an optimization/re-optimization, indicating the dimensions and measures for each optimized data cube.

Aspects described herein can advantageously address issues of query performance during massive (e.g., petabyte-level) data cube mining. Determination and output of dimension/measure communities can be used to identify missing dimensions and metrics of existing (initial) data cube(s) to be optimized and/or identify dimensions/metrics for new data cubes to be generated in order to improve query performance. Further, analysis and optimization discussed herein can be performed on an iterative bases, periodically, aperiodically, triggered based on time, query volume, or any other parameters, to improve big-data cube query performance and align with an enterprise's growth in business metrics and indicators.

FIG. 7 depicts further details of an example data cube generation module (e.g., data cube generation module 700 of FIG. 1) to incorporate and/or use aspects described herein. In one or more aspects, data cube generation 700 includes, in one example, various sub-modules to be used to perform generation of optimized data cubes. The sub-modules can be or include, e.g., computer readable program code (e.g., instructions) in computer readable media, e.g., persistent storage (e.g., persistent storage 113, such as a disk) and/or a cache (e.g., cache 121), as examples. The computer readable media may be part of a computer program product and may be executed by and/or using one or more computers or devices, and/or processor(s) or processing circuitry thereof, such as computer(s) 101, EUD 103, server 104, or computers of cloud 105/106 of FIG. 1, as examples.

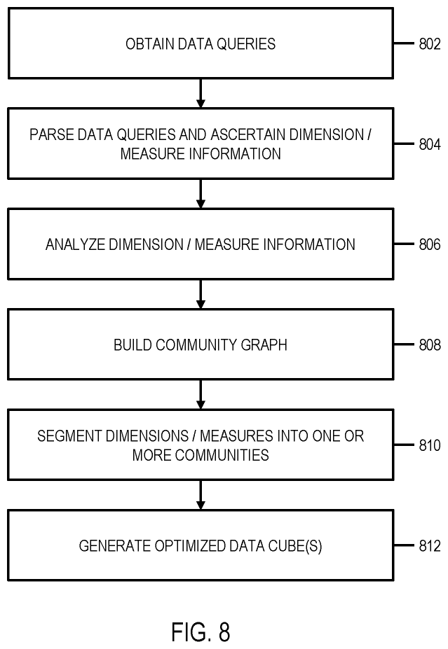

Referring to FIG. 7, data cube generation module 700 includes the following sub-modules query input sub-module 702, query parsing sub-module 704, dimension/measure information analyzing sub-module 706, graph building sub-module 708, segmenting sub-module 710, and optimized data cube generating sub-module 712. The sub-modules of FIG. 7 may be used to perform aspects described herein, for instance aspects discussed with reference to FIG. 8.

FIG. 8 depicts an example process for generation of optimized data cubes, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 8 are part of a module, such as module 700 of FIG. 7. In other examples, the code may be included in one or more modules and/or in one or more sub-modules of the one or more modules. Various options are available.

The process of FIG. 8 begins by obtaining (802), for instance by query input sub-module 702, a collection of data queries. The process continues to 804 with parsing each data query of the collection of data queries and ascertaining from the parsing, dimension and measure information of the collection of data queries. In examples, this is performed by query parsing sub-module 704. The dimension and measure information includes dimension tables and fact tables indicated in the collection of data queries, and the parsing can further ascertain the dimensions corresponding to the dimension tables, metric columns corresponding to the fact tables, and metrics corresponding to the metric columns, where such dimensions, the metric columns, and the metrics are all indicated in the collection of data queries.

In some examples, the parsing uses a dictionary that identifies the dimensions, the dimension tables, the metrics, the metric columns, and the fact tables for correlation to query elements appearing in the collection of data queries.

In some examples, each relationship of the relationships includes co-occurrence of a respective fact table, of the fact tables, and a respective dimension table, of the dimension tables, in the collection of data queries, and a strength of the respective relationship is based on a number of queries, of the collection of data queries, in which the respective fact table and the respective dimension table both appear.

The process of FIG. 8 continues by analyzing (806), for example by dimension/measure information analyzing sub-module 706, the dimension and measure information for relationships between the dimension tables and the fact tables, and strengths of the relationships. The process then builds (808), for instance by graph building sub-module (708) a community graph. In a particular example, building generates, in the community graph: (i) a respective dimension table node for each dimension table of the dimension tables, (ii) a respective fact table node for each fact table of the fact tables, (iii) a respective edge between each fact table node-dimension table node pair that corresponds to a fact table-dimension table pair that co-occurs in the collection of data queries, where the edge is provided with a weight based on a number of queries, of the collection of data queries, in which the respective fact table and the respective data table of the respective fact table-dimension table pair both appear, (iv) a respective dimension node for each dimension of the ascertained dimensions, the respective dimension node being provided as a first child node to the respective dimension table node for the respective dimension table to which the respective dimension corresponds, (v) a respective metric column node for each metric column of the ascertained metric columns, the respective metric column node being provided as a second child node to the respective fact table node for the respective fact table to which the respective metric column corresponds, and (vi) a respective metric node for each metric of the ascertained metrics, the respective metric node being provided as a third child node to the respective metric column node for the respective metric column to which the respective metric corresponds.

Continuing with FIG. 8, the process segments (810), for instance by segmenting sub-module 710, dimensions and measures reflected in the dimension and measure information, including the dimension tables and the fact tables, into one or more communities based on the analyzing. Each such community of the one or more communities includes a respective at least one dimension table of the dimension tables and at least one fact table of the fact tables.

In examples, segmenting the dimensions and the measures into the one or more communities includes segmenting the community graph into subgraphs, of the community graph, that each represent a community of the one or more communities, with each subgraph indicating the at least one dimension table of the respective community represented by the respective subgraph and the at least one fact table of the respective community represented by the respective subgraph. Segmenting the community graph can include applying a community discovery algorithm using weights assigned to edges of the community graph. Each edge of the edges can extend between a respective dimension table node and a respective fact table node, where the weight assigned to the respective edge indicates a strength of a relationship between a respective dimension table represented by the respective dimension table node and a respective fact table represented by the respective fact table node, the strength of the relationship being based on the number of queries, of the collection of data queries, in which the respective dimension table and the respective fact table both appear.

The process of FIG. 8 then generates (812), for instance by optimized data cube generating sub-module 712, one or more optimized data cubes. The generating the optimized data cube(s) includes, for each community of the one or more communities, generating an optimized data cube with a respective dimension table for each of the at least one dimension table of the respective community and a respective fact table for each of the at least one fact table of the respective community. In examples, and for each of the one or more communities, the generating the optimized data cube for the respective community includes: (i) for each dimension table of the at least one dimension table of the respective community indicated by the respective subgraph representing the respective community: (a) generating a dimension table of the optimized data cube, and (b) for each dimension corresponding to the dimension table indicated by the respective subgraph, setting the respective dimension as a dimension field of the generated dimension table of the optimized data cube, and (ii) for each fact table of the at least one fact table of the respective community indicated by the respective subgraph representing the community: (a) generating a fact table of the optimized data cube, and (b) for each metric column corresponding to the fact table indicated by the respective subgraph, setting a respective measure field of the generated fact table of the optimized data cube and, for each metric corresponding to the respective metric column, setting a respective measure of the measure field of the generated fact table of the optimized data cube.

In some examples, the collection of data queries is obtained from a query history that includes queries made against one or more initial data cubes, and the one or more optimized data cubes are provided in place of the one or more initial data cubes for satisfying incoming queries. Further, in some examples, the analyzing, segmenting, and generating identifies and includes in the one or more optimized data cubes at least one selected from the group consisting of: (i) at least one dimension that was not included in the one or more initial data cubes, and (ii) at least one metric that was not included in the one or more initial data cubes. Additionally or alternatively, in situations where the one or more optimized data cubes are used as an initial one or more optimized data cubes, a process can iterate the optimization, for instance by iterating one of more times: obtaining a next collection of data queries and repeating, using the next collection of data queries, aspects of FIG. 8, for instance the parsing (804), the analyzing (806), the segmenting (810), and the generating (812), to generate the one or more optimized data cubes as a next one or more optimized data cubes, where the next one or more optimized data cubes are provided in place of the initial one or more data cubes for satisfying incoming queries.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
obtaining a collection of data queries;
parsing each data query of the collection of data queries and ascertaining, from the parsing, dimension and measure information of the collection of data queries, the dimension and measure information comprising dimension tables and fact tables indicated in the collection of data queries;
analyzing the dimension and measure information for relationships between the dimension tables and the fact tables, and strengths of the relationships;
segmenting dimensions and measures reflected in the dimension and measure information, including the dimension tables and the fact tables, into one or more communities based on the analyzing, each community of the one or more communities comprising a respective at least one dimension table of the dimension tables and at least one fact table of the fact tables; and
generating one or more optimized data cubes, the generating the one or more optimized data cubes comprising, for each community of the one or more communities, generating an optimized data cube with a respective dimension table for each of the at least one dimension table of the respective community and a respective fact table for each of the at least one fact table of the respective community.

2. The method of claim 1, wherein the parsing further ascertains the dimensions, the dimensions corresponding to the dimension tables, metric columns corresponding to the fact tables, and metrics corresponding to the metric columns, the dimensions, the metric columns, and the metrics being indicated in the collection of data queries.

3. The method of claim 2, wherein the parsing uses a dictionary that identifies the dimensions, the dimension tables, the metrics, the metric columns, and the fact tables for correlation to query elements appearing in the collection of data queries.

4. The method of claim 2, wherein each relationship of the relationships comprises co-occurrence of a respective fact table, of the fact tables, and a respective dimension table, of the dimension tables, in the collection of data queries, wherein a strength of the respective relationship is based on a number of queries, of the collection of data queries, in which the respective fact table and the respective dimension table both appear.

5. The method of claim 2, further comprising building a community graph, wherein the building generates, in the community graph:
a respective dimension table node for each dimension table of the dimension tables;
a respective fact table node for each fact table of the fact tables;
a respective edge between each fact table node-dimension table node pair that corresponds to a fact table-dimension table pair that co-occurs in the collection of data queries, wherein the edge is provided with a weight based on a number of queries, of the collection of data queries, in which the respective fact table and the respective data table of the respective fact table-dimension table pair both appear;
a respective dimension node for each dimension of the ascertained dimensions, the respective dimension node being provided as a first child node to the respective dimension table node for the respective dimension table to which the respective dimension corresponds;
a respective metric column node for each metric column of the ascertained metric columns, the respective metric column node being provided as a second child node to the respective fact table node for the respective fact table to which the respective metric column corresponds; and
a respective metric node for each metric of the ascertained metrics, the respective metric node being provided as a third child node to the respective metric column node for the respective metric column to which the respective metric corresponds.

6. The method of claim 5, wherein the segmenting the dimensions and the measures into the one or more communities comprises segmenting the community graph into subgraphs, of the community graph, that each represent a community of the one or more communities, and each subgraph indicating the at least one dimension table of the respective community represented by the respective subgraph and the at least one fact table of the respective community represented by the respective subgraph.

7. The method of claim 6, wherein the segmenting the community graph comprises applying a community discovery algorithm using weights assigned to edges of the community graph.

8. The method of claim 7, wherein each edge of the edges extends between a respective dimension table node and a respective fact table node, wherein a weight assigned to the respective edge indicates a strength of a relationship between a respective dimension table represented by the respective dimension table node and a respective fact table represented by the respective fact table node, the strength of the relationship based on the number of queries, of the collection of data queries, in which the respective dimension table and the respective fact table both appear.

9. The method of claim 5, wherein, for each of the one or more communities, the generating the optimized data cube for the respective community comprises:
for each dimension table of the at least one dimension table of the respective community indicated by the respective subgraph representing the respective community:
generating a dimension table of the optimized data cube; and
for each dimension corresponding to the dimension table indicated by the respective subgraph, setting the respective dimension as a dimension field of the generated dimension table of the optimized data cube; and
for each fact table of the at least one fact table of the respective community indicated by the respective subgraph representing the community:
generating a fact table of the optimized data cube; and
for each metric column corresponding to the fact table indicated by the respective subgraph, setting a respective measure field of the generated fact table of the optimized data cube and, for each metric corresponding to the respective metric column, setting a respective measure of the measure field of the generated fact table of the optimized data cube.

10. The method of claim 1, wherein the collection of data queries is obtained from a query history comprising queries made against one or more initial data cubes, wherein the one or more optimized data cubes are provided in place of the one or more initial data cubes for satisfying incoming queries, and wherein the analyzing, segmenting, and generating identifies and includes in the one or more optimized data cubes at least one selected from the group consisting of: (i) at least one dimension that was not included in the one or more initial data cubes, and (ii) at least one metric that was not included in the one or more initial data cubes.

11. The method of claim 1, wherein the one or more optimized data cubes are used as an initial one or more optimized data cubes, and wherein the method further comprises iterating, one or more times: obtaining a next collection of data queries and repeating, using the next collection of data queries, the parsing, the analyzing, the segmenting, and the generating to generate the one or more optimized data cubes as a next one or more optimized data cubes, wherein the next one or more optimized data cubes are provided in place of the initial one or more data cubes for satisfying incoming queries.

12. A computer system comprising:
a memory; and
a processor in communication with the memory, wherein the computer system is configured to perform a method comprising:
obtaining a collection of data queries;
parsing each data query of the collection of data queries and ascertaining, from the parsing, dimension and measure information of the collection of data queries, the dimension and measure information comprising dimension tables and fact tables indicated in the collection of data queries;
analyzing the dimension and measure information for relationships between the dimension tables and the fact tables, and strengths of the relationships;
segmenting dimensions and measures reflected in the dimension and measure information, including the dimension tables and the fact tables, into one or more communities based on the analyzing, each community of the one or more communities comprising a respective at least one dimension table of the dimension tables and at least one fact table of the fact tables; and
generating one or more optimized data cubes, the generating the one or more optimized data cubes comprising, for each community of the one or more communities, generating an optimized data cube with a respective dimension table for each of the at least one dimension table of the respective community and a respective fact table for each of the at least one fact table of the respective community.

13. The computer system of claim 12, wherein the parsing further ascertains the dimensions, the dimensions corresponding to the dimension tables, metric columns corresponding to the fact tables, and metrics corresponding to the metric columns, the dimensions, the metric columns, and the metrics being indicated in the collection of data queries.

14. The computer system of claim 13, further comprising building a community graph, wherein the building generates, in the community graph:
a respective dimension table node for each dimension table of the dimension tables;
a respective fact table node for each fact table of the fact tables;
a respective edge between each fact table node-dimension table node pair that corresponds to a fact table-dimension table pair that co-occurs in the collection of data queries, wherein the edge is provided with a weight based on a number of queries, of the collection of data queries, in which the respective fact table and the respective data table of the respective fact table-dimension table pair both appear;
a respective dimension node for each dimension of the ascertained dimensions, the respective dimension node being provided as a first child node to the respective dimension table node for the respective dimension table to which the respective dimension corresponds;
a respective metric column node for each metric column of the ascertained metric columns, the respective metric column node being provided as a second child node to the respective fact table node for the respective fact table to which the respective metric column corresponds; and
a respective metric node for each metric of the ascertained metrics, the respective metric node being provided as a third child node to the respective metric column node for the respective metric column to which the respective metric corresponds.

15. The computer system of claim 14, wherein the segmenting the dimensions and the measures into the one or more communities comprises segmenting the community graph into subgraphs, of the community graph, that each represent a community of the one or more communities, and each subgraph indicating the at least one dimension table of the respective community represented by the respective subgraph and the at least one fact table of the respective community represented by the respective subgraph, and wherein the segmenting the community graph comprises applying a community discovery algorithm using weights assigned to edges of the community graph.

16. The computer system of claim 15, wherein each edge of the edges extends between a respective dimension table node and a respective fact table node, wherein a weight assigned to the respective edge indicates a strength of a relationship between a respective dimension table represented by the respective dimension table node and a respective fact table represented by the respective fact table node, the strength of the relationship based on the number of queries, of the collection of data queries, in which the respective dimension table and the respective fact table both appear.

17. The computer system of claim 14, wherein, for each of the one or more communities, the generating the optimized data cube for the respective community comprises:
for each dimension table of the at least one dimension table of the respective community indicated by the respective subgraph representing the respective community:
generating a dimension table of the optimized data cube; and
for each dimension corresponding to the dimension table indicated by the respective subgraph, setting the respective dimension as a dimension field of the generated dimension table of the optimized data cube; and
for each fact table of the at least one fact table of the respective community indicated by the respective subgraph representing the community:
generating a fact table of the optimized data cube; and
for each metric column corresponding to the fact table indicated by the respective subgraph, setting a respective measure field of the generated fact table of the optimized data cube and, for each metric corresponding to the respective metric column, setting a respective measure of the measure field of the generated fact table of the optimized data cube.

18. The computer system of claim 12, wherein the collection of data queries is obtained from a query history comprising queries made against one or more initial data cubes, wherein the one or more optimized data cubes are provided in place of the one or more initial data cubes for satisfying incoming queries, and wherein the analyzing, segmenting, and generating identifies and includes in the one or more optimized data cubes at least one selected from the group consisting of: (i) at least one dimension that was not included in the one or more initial data cubes, and (ii) at least one metric that was not included in the one or more initial data cubes.

19. The computer system of claim 12, wherein the one or more optimized data cubes are used as an initial one or more optimized data cubes, and wherein the method further comprises iterating, one or more times: obtaining a next collection of data queries and repeating, using the next collection of data queries, the parsing, the analyzing, the segmenting, and the generating to generate the one or more optimized data cubes as a next one or more optimized data cubes, wherein the next one or more optimized data cubes are provided in place of the initial one or more data cubes for satisfying incoming queries.

20. A computer program product comprising:
a computer readable storage medium readable by a processing circuit and storing instructions for execution by the processing circuit for performing a method comprising:
obtaining a collection of data queries;
parsing each data query of the collection of data queries and ascertaining, from the parsing, dimension and measure information of the collection of data queries, the dimension and measure information comprising dimension tables and fact tables indicated in the collection of data queries;
analyzing the dimension and measure information for relationships between the dimension tables and the fact tables, and strengths of the relationships;
segmenting dimensions and measures reflected in the dimension and measure information, including the dimension tables and the fact tables, into one or more communities based on the analyzing, each community of the one or more communities comprising a respective at least one dimension table of the dimension tables and at least one fact table of the fact tables; and
generating one or more optimized data cubes, the generating the one or more optimized data cubes comprising, for each community of the one or more communities, generating an optimized data cube with a respective dimension table for each of the at least one dimension table of the respective community and a respective fact table for each of the at least one fact table of the respective community.
